(19) United States
(12) Patent Application Publication
(10) Pub. No.: US 2007/0164652 A1
(43) Pub. Date: Jul. 19, 2007

(54) Field emission flat lamp and fabricating method thereof, and cathode plate and fabricating method thereof

(76) Inventors: Chuan-Hsu Fu, Gonkuan Township (TW); Biing-Nan Lin, Taichung City (TW); Wei-Yi Lin, Tuku Township (TW); Ming-Hung Lin, Taipei City (TW)

Correspondence Address: J.C. Patents, Inc., Suite 250, 4 Venture, Irvine, CA, 92618, US

(21) Appl. No.: 11/436,921

(22) Filed: May 17, 2006

(30) Foreign Application Priority Data
Jan. 18, 2006 (TW) 95101884

(51) Int. Cl. H01J 63/04; H01J 1/62; H01J 9/24

(52) U.S. Cl. 313/495; 313/497; 445/24

(57) ABSTRACT

A cathode plate including a substrate, a plurality of cathode structures, a plurality of gate structures, and an emission layer is provided. The cathode structures and the gate structures are strip-shaped and disposed on the substrate. The cathode structures and the gate structures are parallel interlaced with one another. Each of the cathode structures has at least one groove, and the emission layer is disposed in the grooves. A field emission flat lamp including the above cathode plate, an anode plate, and a sealant is provided. The sealant is disposed between and seals the cathode plate and the anode plate. With the grooves on the cathode structures, the emission layer is positioned precisely to improve the light uniformity of the field emission flat lamp.

### CROSS-REFERENCE TO RELATED APPLICATION

This application claims the priority benefit of Taiwan application serial no. 95101884, filed on Jan. 18, 2006. All disclosure of the Taiwan application is incorporated herein by reference.

### BACKGROUND OF THE INVENTION

1. Field of Invention

The present invention relates to a flat lamp and a cathode thereof and a method for fabricating the cathode, and more particularly, to a field emission flat lamp and a fabricating method thereof and a cathode plate and fabricating method thereof.

2. Description of Related Art

The luminescence principle of the field emission display is to absorb electrons in the top end of materials by utilizing the electric field in a vacuum environment, and the field emission electrons from the cathode plate accelerate to be absorbed and bombard to the fluorescent powder of the anode due to the positive voltage over the anode, thus the luminescence occurs. The cathode plate is used as the field electron emission source, and the anode plate is used as the light-emitting source. The luminescence occurs with the electrons emitted from the cathode plate bombarding to the fluorescent layer of the anode plate. When the field emission display is used as the backlight source of other elements, it is a flat luminous element with a more preferred light uniformity compared with the cold cathode fluorescent lamp (CCFL) or the light emitting diode (LED).

FIG. 1 is a schematic cross-sectional view of a conventional field emission flat lamp. FIG. 2 is a picture corresponding to the region S10 in FIG. 1. Referring to FIG. 1, the conventional field emission flat lamp 100 is mainly composed of a cathode plate 110 and an anode plate 120, wherein the cathode plate 110 has a plurality of gate structures 112 and a plurality of cathode structures 114 disposed thereon. The gate structures 112 and the cathode structures 114 are parallel interlaced with one another. An emission layer 116 is formed on the cathode structures 114 through screen printing.

However, the emission layer 116 cannot be precisely aligned with the cathode structures 114 and formed thereon with fixed line width through the screen printing, but varies irregularly just like the one shown in FIG. 2. Thus, the emission layer 116 cannot be disposed precisely in the center of the cathode structures 114. In other words, the distance between the emission layers 116 on adjacent two cathode structures 114 is not fixed. Thus, the field-emission electric field distribution is non-uniform during the luminescence of the field emission flat lamp 100, such that the light uniformity of the field emission flat lamp 100 is poor.

Since the light source uniformity required by the current displays is of an extremely high standard, if the conventional field emission flat lamp is to be used as a light source for displays, a diffusion film is required to improve the light uniformity, which will increase the assembling complexity of displays and further increase the cost of raw materials and the assembling process. Thus, the conventional field emission flat lamp is not suitable for being widely applied in the market.

### SUMMARY OF THE INVENTION

An object of the present invention is to provide a cathode plate with an advantage that the emission layer can be precisely positioned.

Another object of the present invention is to provide a field emission flat lamp with an advantage of desirable light uniformity.

Still another object of the present invention is to provide a method for fabricating the cathode plate, which can solve the problem of poor light uniformity resulting from imprecise positioning of the emission layer.

Yet another object of the present invention is to provide a method for fabricating the field emission flat lamp, which can solve the problem of poor light uniformity resulting from imprecise positioning of the emission layer.

The present invention provides a cathode plate, which includes a substrate, a plurality of cathode structures, a plurality of gate structures, and an emission layer. The cathode structures and the gate structures are disposed on the substrate and in a strip-form. The gate structures and the cathode structures are parallel interlaced with one another. Each of the cathode structures has at least one groove, and the emission layer is disposed in the grooves.

The present invention further provides a field emission flat lamp, which includes a cathode plate, an anode plate, and a sealant. The cathode plate includes a first substrate, a plurality of cathode structures, a plurality of gate structures, and an emission layer. The cathode structures and the gate structures are disposed on the first substrate and in a strip-form. The gate structures and the cathode structures are parallel interlaced with one another. Each of the cathode structures has at least one groove, and the emission layer is disposed in the grooves. The sealant is disposed between and seals the anode plate and the cathode plate.

In an embodiment of the above field emission flat lamp and the cathode plate, the (first) substrate is exposed by the grooves, and the substrate is in contact with the emission layer.

In an embodiment of the above field emission flat lamp and the cathode plate, the grooves are strip shaped, and they are arranged in parallel with the cathode structures.

In an embodiment of the above field emission flat lamp and the cathode plate, each of the cathode structures has a plurality of spot-shaped grooves. Moreover, the grooves are arranged in rows along the extending direction of the cathode structures, for example. In addition, the shape of the groove seen from the top can be round, semi-round, semi-ellipse, or ellipse. Alternatively, it also can be in the shape of a polygon, such as a rectangle, triangle, or quadrilateral.

In an embodiment of the above field emission flat lamp, the anode plate includes a second substrate, an anode layer, and a fluorescent layer, wherein the anode layer is disposed on a surface of the second substrate opposite to the cathode plate, and the fluorescent layer is disposed on the anode layer.

The present invention further provides a method for fabricating the cathode plate, which includes: providing a substrate; and forming a plurality of cathode structures and a plurality of gate structures on the substrate, wherein the cathode structures and the gate structures are in a strip-form, and the cathode structures and the gate structures are parallel interlaced with one another, and each of the cathode structures has at least one groove; and forming an emission layer in the grooves.

The present invention further provides a method for fabricating the field emission flat lamp, which includes: providing a cathode plate, with the same fabricating method as that mentioned above; providing an anode plate; and sealing the anode plate and cathode plate with a sealant, wherein the cathode structures, the gate structures, and the emission layer are located between the anode plate and the cathode plate.

In an embodiment of the above method for fabricating the field emission flat lamp and the cathode plate, the process for forming the cathode structures and the gate structures includes screen printing. Alternatively, the process for forming the cathode structures and the gate structures can be a thin film deposition process and a photolithography and etching process.

In an embodiment of the above method for fabricating the field emission flat lamp and the cathode plate, the process for forming the emission layer includes filling an emission layer material on the cathode structures; and removing the emission layer material outside the grooves to form the emission layer. Moreover, the process for filling the emission layer material is, for example, screen printing. In addition, the emission layer material can be activated while removing the emission layer material outside the grooves.

In an embodiment of the above method for fabricating the Field emission flat lamp and the cathode plate, the process for forming the emission layer includes disposing a catalyst in the grooves; and forming the emission layer in the grooves through the catalyst.

To sum up, as for the field emission flat lamp and the fabricating method thereof and the cathode plate and the fabricating method thereof provided by the present invention, the cathode structures are provided with grooves, such that the emission layer can be precisely positioned in the grooves of the cathode structures to improve the light uniformity of the field emission flat lamp.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a conventional field emission flat lamp.

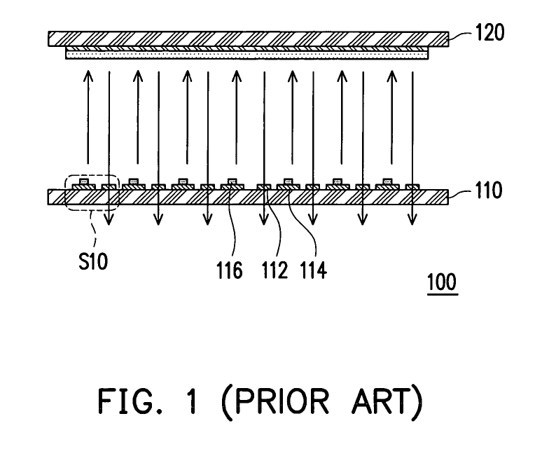

FIG. 2 is a picture corresponding to the region S10 in FIG. 1.

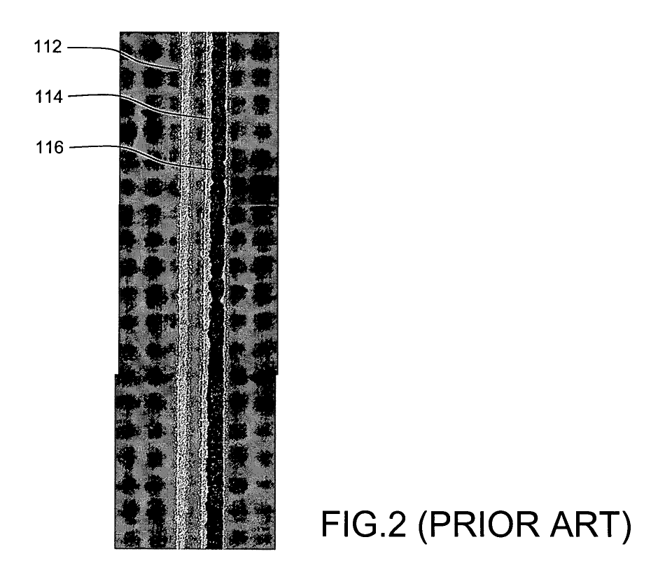

FIG. 3 is a schematic cross-sectional view of a field emission flat lamp according to an embodiment of the present invention.

FIG. 4 is a picture taken from the top of a part of the cathode plate in FIG. 3.

FIGS. 5A and 5B show configurations of the cathode structures, the gate structures, and the emission layer of the cathode plate according to two additional embodiments of the present invention.

FIGS. 6A-6D are cross-sectional views of the fabrication flow of the cathode plate according to an embodiment of the present invention.

### DESCRIPTION OF EMBODIMENTS

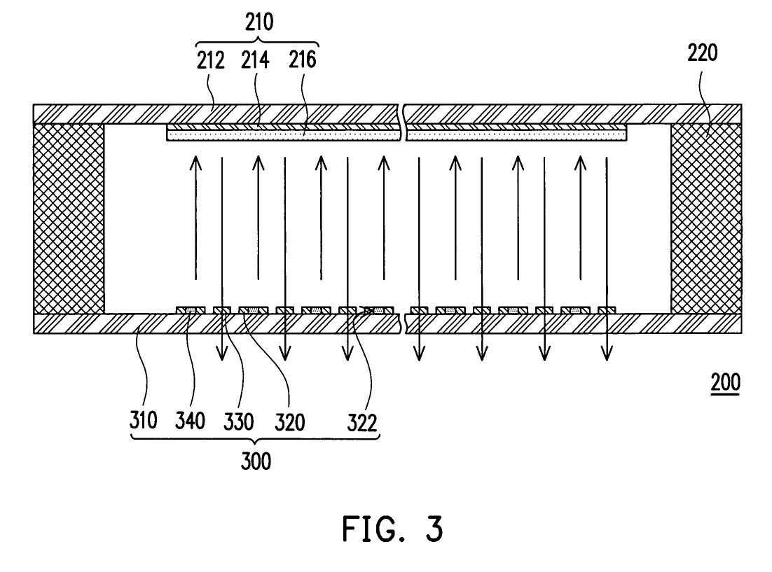

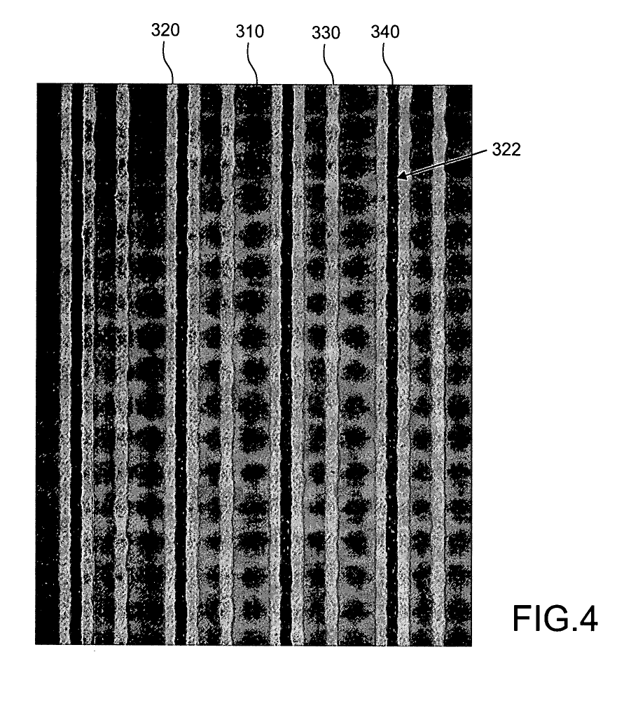

FIG. 3 is a schematic cross-sectional view of a field emission flat lamp according to an embodiment of the present invention. FIG. 4 is a picture taken from the top of a part of the cathode plate in FIG. 3. Referring to FIG. 3, the field emission flat lamp 200 of this embodiment includes a cathode plate 300, an anode plate 210, and a sealant 220. The sealant 220 is disposed between and seals the anode plate 210 and the cathode plate 300. For example, the sealant 220 can be glass cement or another suitable material. In addition, the sealant 220 plays the role as a support to maintain an appropriate gap between the anode plate 210 and the cathode plate 300. Furthermore, a support (not shown) also can be disposed or fabricated between the anode plate 210 and the cathode plate 300 so as to maintain the appropriate gap.

Referring to FIGS. 3 and 4, the cathode plate 300 of this embodiment includes a substrate 310, a plurality of cathode structures 320, a plurality of gate structures 330, and an emission layer 340. The cathode structures 320 and the gate structures 330 are disposed on the substrate 310 and both are strip-shaped (as shown in FIG. 4). The gate structures 330 and the cathode structures 320 are parallel interlaced with one another. Each of the cathode structures 320 has at least one groove 322, and the emission layer 340 is disposed in the grooves 322. The substrate 310 is exposed, for example, by the grooves 322, i.e., the emission layer 340 filled in the grooves 322 is in contact with the substrate 310. In view of the above, since the grooves 322 on the cathode structures 320 are helpful for the precise positioning of the emission layer 340, the emission layer 340 can be aligned with the cathode structures 320 and formed thereon with a fixed line width as shown in the picture of FIG. 4, and the line width will not vary irregularly, and it will not be inaccurately positioned as that of the conventional art. In other words, when the cathode plate 300 of this embodiment is applied to the field emission flat lamp 200, since the distance between the emission layers 340 on two adjacent cathode structures 320 is fixed, the field-emission electric field distribution is uniform, thus dramatically improving the light uniformity of the field emission flat lamp 200.

Referring to FIG. 3, the anode plate 210 of this embodiment includes a substrate 212, an anode layer 214, and a fluorescent layer 216. The anode layer 214 is disposed on the surface of the substrate 212 opposite to the cathode plate 300, and the fluorescent layer 216 is disposed on the anode layer 214. Specifically, the anode layer 214 and the fluorescent layer 216 are located between the substrate 212 and the cathode plate 300. Moreover, the anode layer 214 may also have the function of reflecting light.

When the field emission flat lamp 200 is used as a backlight source for displays (not shown), the cathode plate 300 serves as a light exiting surface and is disposed towards the display panel (not shown), thus preventing the liquid crystal display panel from being influenced by the high heat generated on anode plate 210 after the electrons bombarding to the fluorescent powder. When the field emission flat lamp 200 is configured in the way as mentioned above, the substrate 212 can employ transparent or nontransparent materials, and the anode layer 214 can employ electrical conductive materials with high light reflectance, such as Ag, Al . . . etc., to improve light utility efficiency. Additionally, since the reflected light has to transmit through the cathode plate 300, the substrate 310 is preferably made of transparent materials, and the cathode structures 320 and the gate structures 330 are arranged parallel to one another in strip-form, so as to improve the light transmittance. However, when the field emission flat lamp 200 is not disposed in displays in the way as mentioned above, the substrate 212 and the substrate 310 can be modified to use transparent or nontransparent materials.

In a case that the application of the cathode plate 300 is not restricted, the material of the substrate 310 can be transparent materials, such as glass, or other, nontransparent materials. The material of the cathode structures 320 and the gate structures 330 is conductive material, such as Ag or other suitable metal or non-metal material. The material of the emission layer 340 is, for example, a carbon nanotube (CNT) or other materials suitable for the field electron emission source. The CNT can be formed through arc evaporation, laser ablation of graphite, or chemical vapor deposition (CVD).

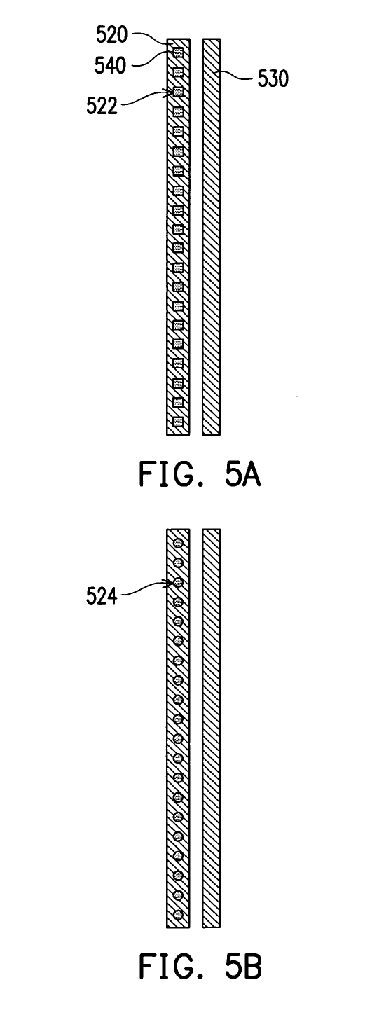

FIGS. 5A and 5B show the configurations of the cathode structures, the gate structures, and the emission layer of the cathode plate according to two additional embodiments of the present invention. Referring to FIG. 4, the grooves 322 of the cathode structures 320 are strip shaped, for example, and they are arranged in parallel with the cathode structures 320, i.e., the emission layer 340 is strip shaped and is arranged in parallel with the cathode structures 320 when seen from the top. Referring to FIG. 5A, each of the cathode structures 520 can also has a plurality of spot-shaped grooves 522. Moreover, the grooves 522 are arranged in rows along the extending direction of the cathode structures 520, for example. In addition, the shape of the grooves 522 can be quadrilateral when seen from the top as shown in FIG. 5A, or can be round shaped as shown in FIG. 5B. Of course, when seen from the top, the shape of the grooves 522 can also be polygonal, elliptical, semi-round, semi-elliptical, triangular, quadrilateral, or other shape, which is not restricted herein.

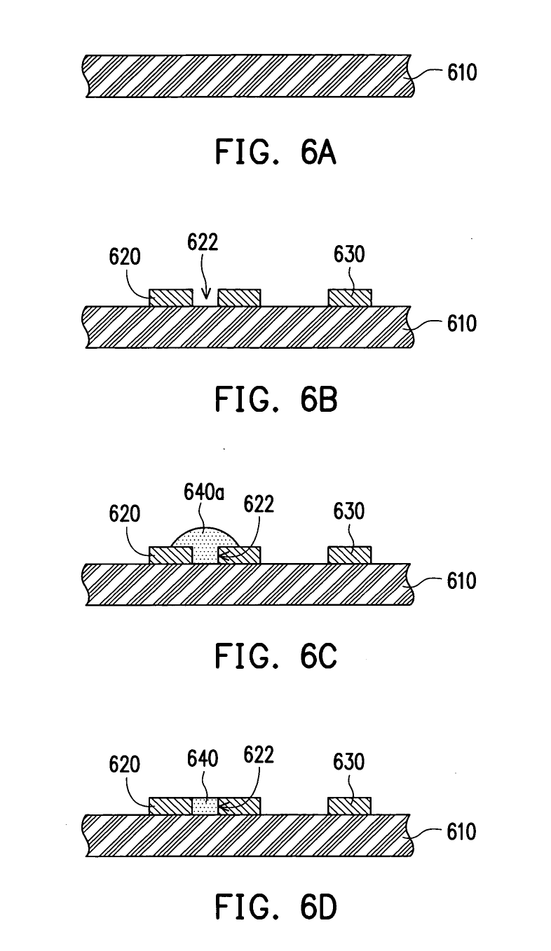

The method for fabricating the cathode plate according to an embodiment of the present invention will be described below with reference to the drawings, and the drawings only depict a part of the cathode plate. Referring to FIG. 6A, in the method for fabricating the cathode plate of this embodiment, a substrate 610 is provided first. Then, referring to FIG. 6B, a plurality of cathode structures 620 and a plurality of gate structures 630 are formed on the substrate 610. Similar to the cathode structures 320 and the gate structures 330 in FIG. 4, the cathode structures 620 and the gate structures 630 are also strip shaped, and they are parallel interlaced with one another. Each of the cathode structures 620 has at least one groove 622. Then, referring to FIG. 6D, an emission layer 640 is formed in the grooves 622.

Moreover, the cathode structures 620 and the gate structures 630 as shown in FIG. 6B are formed, for example, through screen printing. Alternatively, the cathode structures 620 and the gate structures 630 shown in FIG. 6B also can be formed through a physical or chemical thin film deposition process first, and then through exposure and development processes.

In addition, the method for forming the emission layer 640 as shown in FIG. 6D includes the following steps. Referring to FIG. 6C, an emission layer material 640a is filled on the cathode structures 620 first, and the emission layer material 640a is filled in the grooves 622. The process for filling the emission layer material 640a is slurring the carbon nanotube (CNT) or other types of emission layer materials 640a first, and then coating the slurry on the cathode structures 620 through screen printing, for example. Alternatively, a catalyst (not shown) may be formed in the groove 622 of the cathode structures 620, and then the emission layer material 640a can be formed on the cathode structures 620 through the catalyst. Before the catalyst is formed in the grooves 622, a protective layer (not shown) can be used to cover the substrate 610, the cathode structures 620, and the gate structures 630; and only the grooves 622 are exposed, such that the catalyst is only formed in the grooves 622. Referring to FIG. 6D, then the emission layer material 640a outside the grooves 622 is removed to form the emission layer 640. Moreover, the emission layer material 640a can be activated while removing the emission layer material 640a outside the grooves 622. Since the deactivation may occur to the surface of the emission layer material 640a after it has been disposed on the cathode structures 620, it can be activated by removing the emission layer material 640a outside the grooves 622.

What has been described above is the method for fabricating the cathode plate according to an embodiment of the present invention. The present invention also provides a method for fabricating a field emission flat lamp. Herein, in an embodiment of the method for fabricating the field emission flat lamp, the cathode plate 300 shown in FIG. 3 is fabricated through the method shown in FIGS. 6A-6D, and an anode plate 210 shown in FIG. 3 is provided. Then, the anode plate 210 and the cathode plate 300 are sealed by the sealant 220 shown in FIG. 3 to form the field emission flat lamp 200 shown in FIG. 3, wherein the cathode structures 320, the gate structures 330, and the emission layer 340 are located between the anode plate 210 and the cathode plate 300; the field emission flat lamp 200 is, for example, in a vacuum state.

It should be noted that the cathode plate of the present invention is not limited to be applied in field emission flat lamps, and when being applied to field emission displays, it can improve the display quality thereof as well.

To sum up, as for the field emission flat lamp and the fabricating method thereof, and the cathode plate and the fabricating method thereof provided by the present invention, since the cathode structures are designed and provided with grooves thereon, the emission layer can be positioned precisely in the grooves of the cathode structures, such that the distance between the emission layers on two adjacent cathode structures is fixed. Therefore, the field-emission electric field generated by the cathode plate together with the anode plate is uniformly distributed, and the light uniformity of the field emission flat lamp will be dramatically improved. In addition, in field emission flat lamps with desirous light uniformity, the diffusion film is no longer required for improving the light uniformity, such that the assembling complexity of the display is decreased, the cost of raw materials and the assembling process is reduced, which makes it suitable for being widely used in the market.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A cathode plate, comprising:
a substrate;
a plurality of cathode structures, disposed on the substrate, wherein the cathode structures are in a strip-form and are arranged parallel to one another; and each of the cathode structures has at least one groove;
a plurality of gate structures, disposed on the substrate, wherein the gate structures are in strip-form; and the gate structures and the cathode structures are parallel interlaced with one another; and
an emission layer, disposed in the grooves.

2. The cathode plate as claimed in claim 1, wherein the substrate is exposed by the grooves, and the emission layer is in contact with the substrate.

3. The cathode plate as claimed in claim 1, wherein the grooves are in strip-form and are arranged in parallel with the cathode structures.

4. The cathode plate as claimed in claim 1, wherein each of the cathode structures has a plurality of grooves, and the grooves are spot-shaped.

5. The cathode plate as claimed in claim 4, wherein the grooves are arranged in rows along the extending direction of the cathode structures.

6. The cathode plate as claimed in claim 4, wherein the shape of the grooves seen from the top is round, semi-round, semi-elliptical, or elliptical.

7. The cathode plate as claimed in claim 4, wherein the shape of the grooves seen from the top is polygonal.

8. The cathode plate as claimed in claim 7, wherein the shape of the grooves seen from the top is rectangular, triangular, or quadrilateral.

9. A field emission flat lamp, comprising:
a cathode plate, including:
a first substrate;
a plurality of cathode structures, disposed on the first substrate, wherein the cathode structures are in a strip-form and are arranged parallel to one another, and each of the cathode structures has at least one groove;
a plurality of gate structures, disposed on the first substrate, wherein the gate structures are in strip-form, and the gate structures and the cathode structures are parallel interlaced with one another;
an emission layer, disposed in the grooves;
an anode plate, disposed above the cathode plate; and
a sealant, disposed and sealing between the anode plate and the cathode plate.

10. The field emission flat lamp as claimed in claim 9, wherein the first substrate is exposed by the grooves, and the emission layer is in contact with the first substrate.

11. The field emission flat lamp as claimed in claim 9, wherein the grooves are in strip-form and are arranged in parallel with the cathode structures.

12. The field emission flat lamp as claimed in claim 9, wherein each of the cathode structures has a plurality of grooves, and the grooves are spot-shaped.

13. The field emission flat lamp as claimed in claim 12, wherein the grooves are arranged in rows along the extending direction of the cathode structures.

14. The field emission flat lamp as claimed in claim 12, wherein the shape of the grooves seen from the top is round, semi-round, semi-elliptical, or elliptical.

15. The field emission flat lamp as claimed in claim 12, wherein the shape of the grooves seen from the top is polygonal.

16. The field emission flat lamp as claimed in claim 15, wherein the shape of the grooves seen from the top is rectangular, triangular, or quadrilateral.

17. The field emission flat lamp as claimed in claim 9, wherein the anode plate includes:
a second substrate;
an anode layer, disposed on a surface of the second substrate opposite to the cathode plate; and
a fluorescent layer, disposed on the anode layer.

18. A method for fabricating the cathode plate, comprising:
providing a substrate;
forming a plurality of cathode structures and a plurality of gate structures on the substrate, wherein the cathode structures and the gate structures are in a strip-form, and the cathode structures and the gate structures are parallel interlaced with one another, and each of the cathode structures has at least one groove; and
forming an emission layer in the grooves.

19. The method for fabricating the cathode plate as claimed in claim 18, wherein the process for forming the cathode structures and the gate structures includes screen printing.

20. The method for fabricating the cathode plate as claimed in claim 18, wherein the process for forming the cathode structures and the gate structures includes a thin film deposition process and a photolithography and etching process.

21. The method for fabricating the cathode plate as claimed in claim 18, wherein the process for forming the emission layer includes:
filling an emission layer material on the cathode structures; and
removing the emission layer material outside the grooves to form the emission layer.

22. The method for fabricating the cathode plate as claimed in claim 21, wherein the process for filling the emission layer material includes screen printing.

23. The method for fabricating the cathode plate as claimed in claim 21, wherein the emission layer material is further activated while removing the emission layer material outside the grooves.

24. The method for fabricating the cathode plate as claimed in claim 18, wherein the process for forming the emission layer includes:
disposing a catalyst in the grooves; and
forming the emission layer in the grooves through the catalyst.

25. A method for fabricating the field emission flat lamp, comprising:
providing a cathode plate, wherein the process for fabricating the cathode plate includes:
providing a substrate;
forming a plurality of cathode structures and a plurality of gate structures on the substrate, wherein the cathode structures and the gate structures are in a strip-form and the cathode structures and the gate structures are parallel interlaced with one another, and each of the cathode structures has at least one groove;
forming an emission layer in the grooves;
providing an anode plate; and
sealing the anode plate and the cathode plate through a sealant, wherein the cathode structures, the gate structures, and the emission layer are located between the anode plate and the cathode plate.

26. The method for fabricating the field emission flat lamp as claimed in claim 25, wherein the process for forming the cathode structures and the gate structures includes screen printing.

27. The method for fabricating the field emission flat lamp as claimed in claim 25, wherein the process for forming the cathode structures and the gate structures includes a thin film deposition process and a photolithography and etching process.

28. The method for fabricating the field emission flat lamp as claimed in claim 25, wherein the process for forming the emission layer includes:
filling an emission layer material on the cathode structures; and
removing the emission layer material outside the grooves to form the emission layer.

29. The method for fabricating the field emission flat lamp as claimed in claim 28, wherein the process for filling the emission layer material includes screen printing.

30. The method for fabricating the field emission flat lamp as claimed in claim 28, wherein the emission layer material is further activated while removing the emission layer material outside the grooves.

31. The method for fabricating the field emission flat lamp as claimed in claim 25, wherein the process for forming the emission layer includes:
disposing a catalyst in the grooves; and
forming the emission layer in the grooves through the catalyst.
